(19) United States
(12) Patent Application Publication
(10) Pub. No.: US 2013/0022865 A1
(43) Pub. Date: Jan. 24, 2013

(54) CURRENT COLLECTOR AND NONAQUEOUS SECONDARY CELL

(71) Applicants: Shumpei NISHINAKA, Osaka (JP); Naoto Torata, Osaka (JP); Satoshi Arima, Osaka-shi (JP)

(72) Inventors: Shumpei NISHINAKA, Osaka (JP); Naoto Torata, Osaka (JP); Satoshi Arima, Osaka-shi (JP)

(21) Appl. No.: 13/555,578

(22) Filed: Jul. 23, 2012

(30) Foreign Application Priority Data
Jul. 22, 2011 (JP) 2011-160557

(51) Int. Cl. H01M 4/66

(52) U.S. Cl. 429/211

(57) ABSTRACT

A current collector having a multi-layered structure comprising a resin layer (13) sandwiched by metal layers (14), the resin layer (13) being formed from a mixture of a resin material and an adhesive.

This application is based on Japanese Patent Application No. 2011-160557 filed on Jul. 22, 2011, the entire contents of which are hereby incorporated by reference.

### BACKGROUND OF THE INVENTION

1. Field of the Invention

The present invention relates to a current collector and a nonaqueous secondary cell, and particularly relates to a current collector having an insulation layer and a nonaqueous secondary cell that uses this current collector.

2. Description of Related Art

Nonaqueous secondary cells, typified by lithium ion secondary cells, have high capacity and high energy density, and have excellent storage performance, charge-discharge cycle characteristics, and the like. Nonaqueous secondary cells are therefore widely utilized in portable appliances and other consumer appliances. In recent years, because of the rise in awareness relating to environmental problems and energy conservation, lithium ion secondary cells have come to be utilized in power storage applications and onboard applications in electric automobiles and the like.

In addition, because of the high energy density of nonaqueous secondary cells, they have a high risk of abnormal overheating, ignition, and other mishaps when in an overcharged state or exposed to a high-temperature environment. Therefore, various countermeasures pertaining to safety have been taken with nonaqueous secondary cells.

Japanese Patent Application No. 11-102711 proposes a lithium ion secondary cell that uses a current collector having a multi-layered structure in order to prevent ignition due to abnormal overheating.

FIG. 16 is a cross-sectional view showing the current collector of this lithium ion secondary cell. The current collector 500 has a structure in which metal foil 503 are adhered via adhesive layers 502 to both surfaces of a resin film (an insulation layer) 501 having a low melting point of 130 to 170° C. When abnormal overheating occurs in an overcharged state, a high-temperature state, or other state in this lithium ion secondary cell, the low-melting-point resin film 501 melts. The electrodes are broken due to the melting of the resin film 501. The electric current is thereby cut, the increase in temperature of the cell interior is therefore suppressed, and ignition is prevented.

As described above, the conventional current collector described above is extremely effective as a safety countermeasure for a nonaqueous secondary cell.

However, as a result of much investigation, the inventors have discovered a fault whereby the adhesive component of the adhesive layers elutes into the electrolyte when metal foil is adhered to resin film by adhesive layers. Therefore, in a conventional current collector, the adhesive layers lose adhesive strength due to the adhesive layers leaking into the electrolyte. This causes faults such as the metal foil peeling away from the resin film. Consequently, a known problem with conventional current collectors is that the reliability of the cell decreases. The reliability of the cell readily decreases particularly because the adhesive readily leaks into the electrolyte when the interior temperature of the cell rises.

### SUMMARY OF THE INVENTION

The object of the present invention is to resolve problems such as those described above and provide a current collector and nonaqueous secondary cell capable of improving safety and reliability.

As a result of earnest research intended to achieve the object described above, the inventors have discovered that the adhesive can be impeded from leaking into the electrolyte by endowing the resin layer itself in the current collector with an adhesive function.

Specifically, the current collector according to the present invention is a current collector having a multi-layered structure with an insulation layer sandwiched by electrically conductive layers, the insulation layer being configured from a mixture of a resin material and an adhesive.

In this current collector, due to the insulation layer being configured from a mixture of a resin material and an adhesive as described above, the insulation layer can be endowed with an adhesive function. Therefore, the insulation layer can be sandwiched by the electrically conductive layers without the use of adhesive layers. Such a configuration makes it possible to suppress the leaking of the adhesive in the insulation layer into the electrolyte. The electrically conductive layers can thereby be suppressed from peeling away from the insulation layer. Consequently, the reliability of the cell can be improved by producing a cell using such a current collector.

Due to the current collector being configured into a multi-layered structure as described above, the insulation layer of the current collector melts and the electrodes are broken when abnormal overheating occurs in, for example, an overcharged state, a high-temperature state, or the like. The electric current can thereby be cut. Consequently, increases in the interior temperature of the cell can be suppressed, and the occurrence of ignition and other abnormal states can therefore be prevented, for example.

The present invention is the current collector of the configuration described above, the adhesive included in the insulation layer preferably being in a range more than 0 wt % and less than 3 wt % relative to the insulation layer (e.g., the entire insulation layer). With such a configuration, the adhesive in the insulation layer can be effectively suppressed from leaking into the electrolyte. Therefore, because peeling of the electrically conductive layers and other problems can be effectively suppressed, the reliability of the cell can be effectively improved.

In addition, according to the present invention, in the current collector of the configuration described above, the adhesive included in the insulation layer preferably has rosin as a tackifier. With such a configuration, the adhesive in the insulation layer can easily be kept from leaking into the electrolyte.

According to the present invention, in the current collector of the configuration described above, the adhesive is preferably constituted from a tackifier only. With such a configuration, the adhesive concentration in the resin layer can be easily reduced. The adhesive in the insulation layer can thereby be more effectively kept from leaking into the electrolyte while the adhesive function is preserved.

The electrically conductive layer is preferably in direct contact with the insulation layer. The electrically conductive layer is also preferably configured from metal foil.

The current collector of the present invention is a current collector having a multi-layered structure in which an insulation layer is sandwiched by metal foil, the insulation layer being composed of a resin material, and the metal foil being in direct contact with the insulation layer.

In this current collector, due to the insulation layer being configured from a resin material as described above, the resin material has an adhesive function to a certain extent. Therefore, the insulation layer can be endowed with an adhesive function. Due to the metal foil being directly adhered to the insulation layer without the use of adhesive layers, a current conductor having a multi-layered configuration with no adhesive can be obtained. Therefore, because there is no adhesive that leaks into the electrolyte, it is possible to prevent metal foil peeling which results from the adhesive leaking into the electrolyte.

Because the current collector has a multi-layered structure in which the insulation layer is sandwiched by metal foil, safety can be improved.

According to the present invention, in the current collector of the configuration described above, the melting point of the resin layer is preferably 120° C. or more and 200° C. or less. With such a configuration, the insulation layer of the current collector readily melts when abnormal overheating occurs in an overcharged state, a high-temperature state, or the like, for example. Therefore, the electrodes are broken readily, and safety can be further improved.

The nonaqueous secondary cell of the present invention is provided with a current collector of the configuration described above and an electrode including an active material layer formed on the current collector. With such a configuration, a nonaqueous secondary cell having improved safety and reliability can easily be obtained.

As described above, according to the present invention, it is easy to obtain a current collector and a nonaqueous secondary cell in which safety and reliability can be improved.

### BRIEF DESCRIPTION OF THE DRAWINGS

FIG. 1 is an exploded perspective view of a lithium ion secondary cell according to the first embodiment;

FIG. 2 is an exploded perspective view of an electrode group of the lithium ion secondary cell according to the first embodiment;

FIG. 3 is an overall perspective view of the lithium ion secondary cell according to the first embodiment;

FIG. 4 is a schematic cross-sectional view showing an enlargement of part of a positive electrode current collector of the lithium ion secondary cell according to the first embodiment;

FIG. 5 is a cross-sectional view (a drawing corresponding to part of a cross section along line A-A of FIG. 7) of a positive electrode of the lithium ion secondary cell according to the first embodiment;

FIG. 6 is a plan view of a positive electrode of the lithium ion secondary cell according to the first embodiment;

FIG. 7 is a perspective view of a positive electrode of the lithium ion secondary cell according to the first embodiment;

FIG. 8 is a cross-sectional view (a drawing showing part of the manufacturing steps of the positive electrode current collector) for describing a positive electrode current collector used in the lithium ion secondary cell according to the first embodiment;

FIG. 9 is a plan view schematically showing part of a positive electrode used in the lithium ion secondary cell according to the first embodiment;

FIG. 10 is a perspective view schematically showing part of an electrode group of the lithium ion secondary cell according to the first embodiment;

FIG. 11 is a cross-sectional view (a drawing corresponding to a cross-section along line B-B of FIG. 13) of a negative electrode of the lithium ion secondary cell according to the first embodiment;

FIG. 12 is a plan view of a negative electrode of the lithium ion secondary cell according to the first embodiment;

FIG. 13 is a perspective view of a negative electrode of the lithium ion secondary cell according to the first embodiment;

FIG. 14 is a plan view of a separator of the lithium ion secondary cell according to the first embodiment;

FIG. 15 is a schematic cross-sectional view showing an enlargement of part of a positive electrode current collector of the lithium ion secondary cell according to the second embodiment; and

FIG. 16 is a cross-sectional view showing a current collector of an example of a conventional lithium ion secondary cell.

### DETAILED DESCRIPTION OF PREFERRED EMBODIMENTS

Embodiments that specify the present invention are described in detail hereinbelow based on the drawings. In the following embodiments, a case is described in which the present invention is applied to a stacked lithium ion secondary cell, one example of a nonaqueous secondary cell.

### First Embodiment

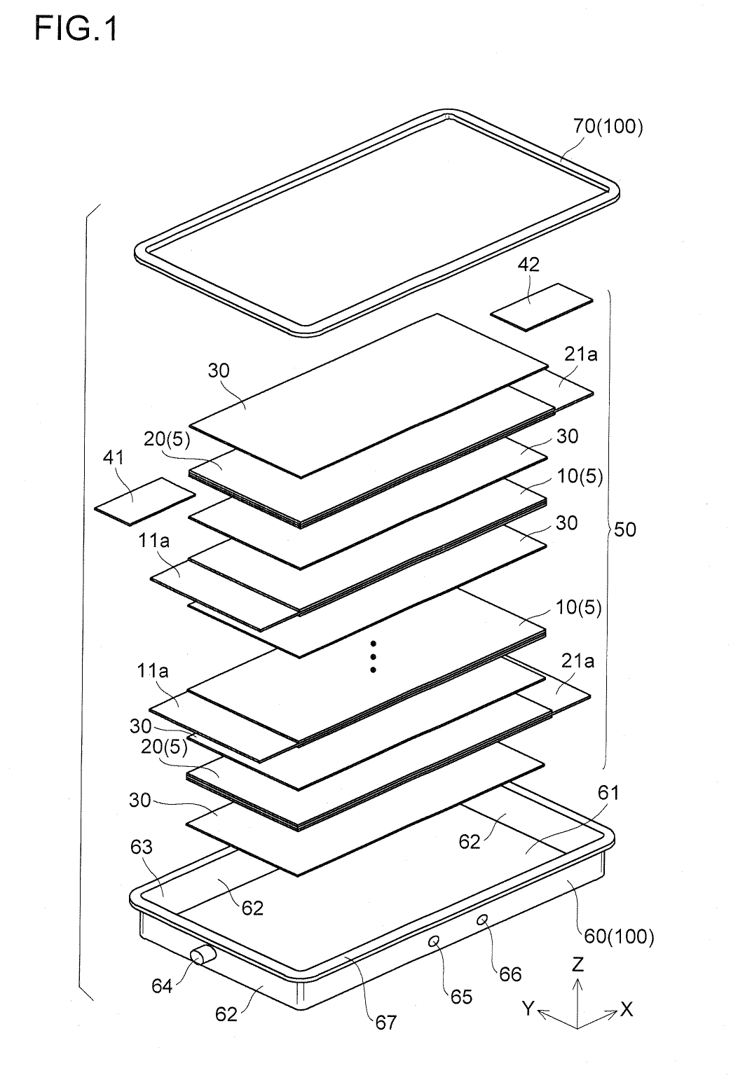

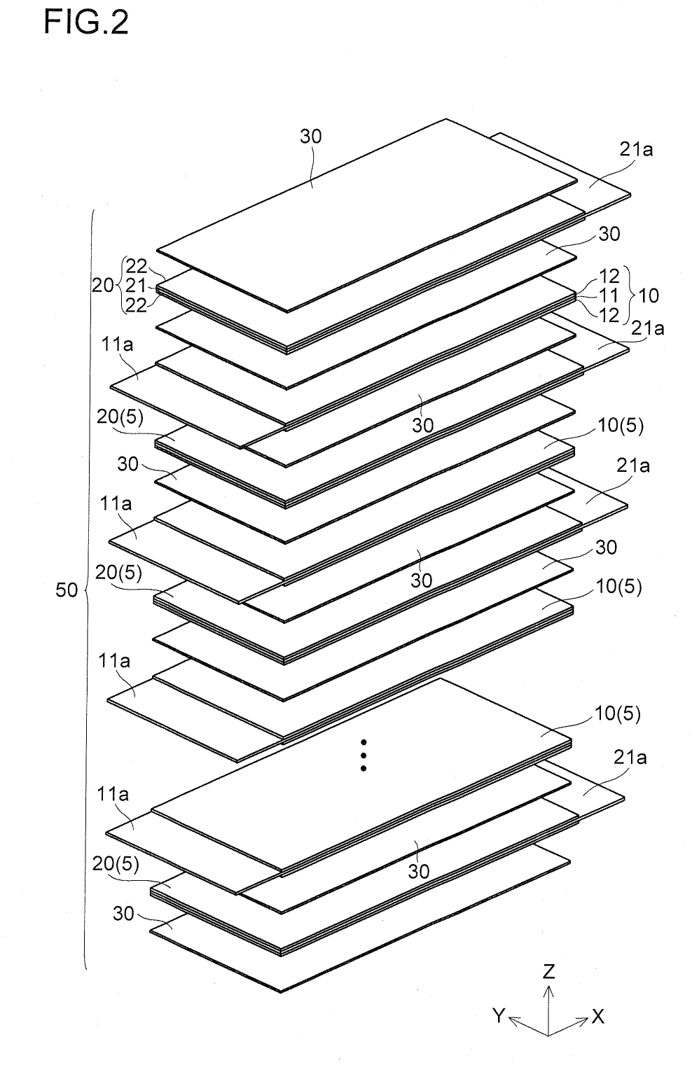

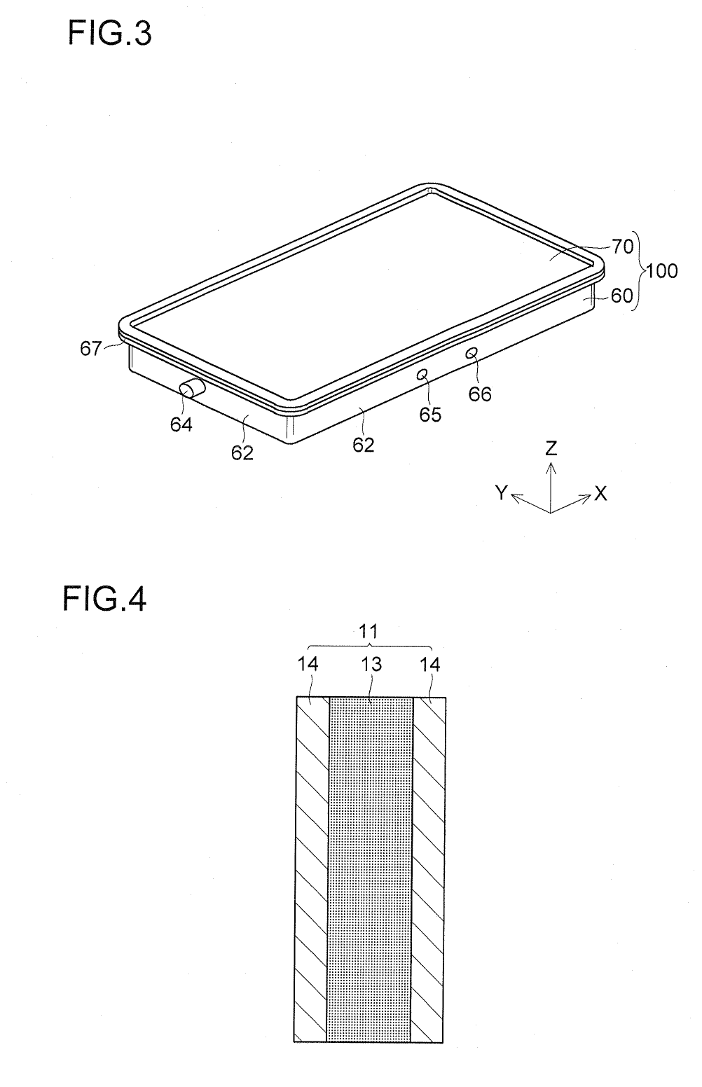

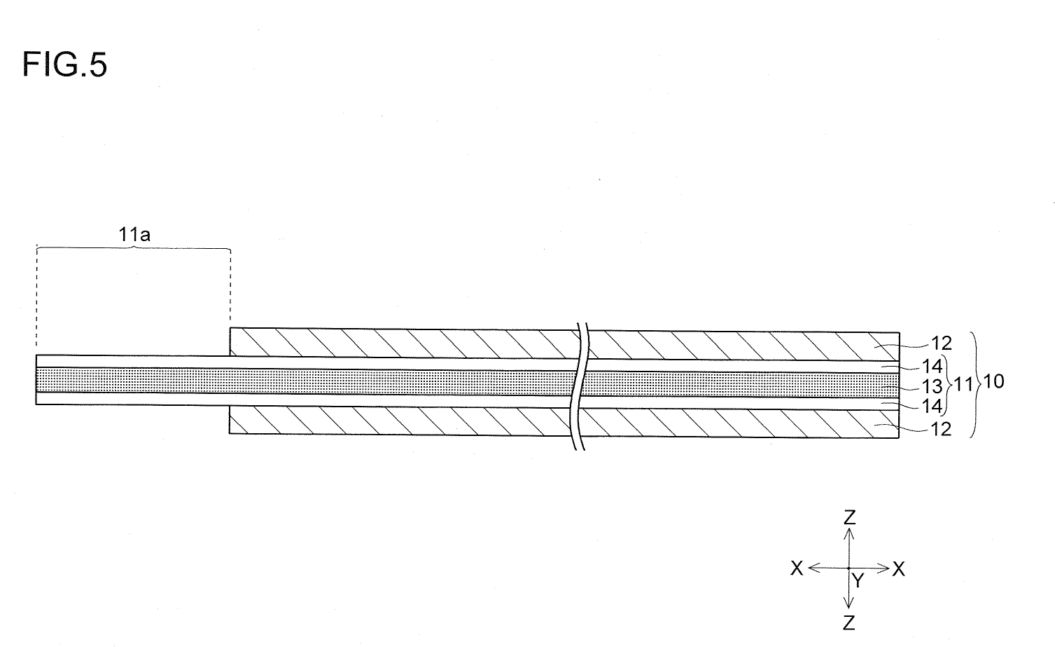

FIG. 1 is an exploded perspective view of a lithium ion secondary cell according to the first embodiment. FIG. 2 is an exploded perspective view of an electrode group of the lithium ion secondary cell according to the first embodiment. FIG. 3 is an overall perspective view of the lithium ion secondary cell according to the first embodiment. FIG. 4 is a schematic cross-sectional view showing an enlargement of part of the positive electrode current collector of the lithium ion secondary cell according to the first embodiment. FIGS. 5 through 14 are drawings for describing the lithium ion secondary cell according to the first embodiment. First, the lithium ion secondary cell and current collector according to the first embodiment will be described with reference to FIGS. 1 through 14.

The lithium ion secondary cell according to the first embodiment is a large secondary cell having a rectangular flat shape and comprising an electrode group 50 (see FIG. 1) including a plurality of electrodes 5, and a metal external container 100 for enclosing the electrode group 50 together with a nonaqueous electrolyte, as shown in FIGS. 1 and 3.

The electrodes 5 are configured including positive electrodes 10 and negative electrodes 20, and between the positive electrodes 10 and negative electrodes 20 are placed separators 30 for suppressing the formation of short circuits in the positive electrodes 10 and the negative electrodes 20, as shown in FIGS. 1 and 2. Specifically, the positive electrodes 10 and the negative electrodes 20 are placed facing each other from opposite sides of the separators 30, and are configured into a stacked structure (stacked body) due to the positive electrodes 10, the separators 30, and the negative electrodes 20 being stacked sequentially. The positive electrodes 10 and the negative electrodes 20 are alternately stacked one by one. The electrode group 50 described above is configured so that one positive electrode 10 is positioned between two adjacent negative electrodes 20.

The electrode group 50 is configured including thirteen positive electrodes 10, fourteen negative electrodes 20, and twenty-eight separators 30, for example, the positive electrodes 10 and the negative electrodes 20 being alternately stacked on opposite sides of the separators 30. Furthermore, the separators 30 are placed on the outermost sides in the electrode group 50 (the outer sides of the outermost layer negative electrodes 20), providing insulation relative to the external container 100.

Each of the positive electrodes 10 constituting the electrode group 50 has a configuration in which positive electrode active material layers 12 are supported on both sides of a positive electrode current collector 11, as shown in FIGS. 4 and 5. The positive electrode current collector 11 has the function of collecting the current of the positive electrode active material layer 12.

In the first embodiment, the positive electrode current collector 11 is formed into a multi-layered structure in which an insulating resin layer 13 is sandwiched by two metal layers 14. The metal layers 14 are one example of the “electrically conductive layers” of the present invention, and the resin layer 13 is one example of the “insulation layer” of the present invention.

The metal layers 14 constituting the positive electrode current collector 11 are configured from aluminum foil or an aluminum alloy foil having a thickness of approximately 4 to 20 μm (e.g., 20 μm), for example. Aluminum can be used suitably as the metal layers 14 of the positive electrode current collector 11 because it passivates readily. The metal layers 14 may also be a material other than aluminum foil or an aluminum alloy foil, e.g., they may be configured from a metal foil of titanium, stainless steel, nickel, or the like; or an alloy foil composed of an alloy of these metals.

In the first embodiment, the resin layer 13 of the positive electrode current collector 11 is configured from a mixture of a resin (a resin material) and an adhesive. A resin adhesive, for example, can be used as such a mixture.

The resin (resin material) constituting the resin layer 13 can be a plastic material composed of a thermoplastic resin, for example. The thermoplastic resin constituting the plastic material can be a polyolefin resin (polyethylene (PE), polypropylene (PP), etc.), polystyrene (PS), polyvinyl chloride, polyamide, and the like, which have a heat distortion temperature of 150° C. or less.

Among these are preferred a polyolefin resin (polyethylene (PE), polypropylene (PP), etc.), polyvinyl chloride, and the like, which at 120° C. have a thermal shrinkage rate of 1.5% or more in any planar direction.

After the layered material constituting the insulation layer (the resin layer 13) is kept for a fixed duration at a fixed temperature, the thermal shrinkage rate can be determined from the distance between two points measured before and after heat treatment. The heat distortion temperature is defined as the lowest temperature at which the thermal shrinkage rate is 10% or more (here, heat distortion temperature<melting point).

Various adhesives that include ethylene vinyl alcohol (EVA) or a special olefin base can be used as the adhesive constituting the resin layer 13. Common adhesives include an adhesive component and a tackifier.

Examples that can be used as the adhesive component include compounds based on copolymers of EVA, styrene-butadiene-styrene (SBS), and styrene-isoprene-styrene (SIS); compounds based on resins or derivatives (e.g., rosin, coumarone, indene, aliphatic compounds, or aromatic hydrocarbon resins); compounds based on copolymers of styrene-ethylene-butylene (SEB) and styrene-ethyelene-butylene-styrene (SEBS); compounds based on polyesters or polyamides; compounds made by combinations of the above-described polymers and copolymers, or polycondensates and copolycondensates; and the like.

Possible examples that can be used as the tackifier include rosin, rosin ester, polyterpene, C5 cyclic and non-cyclic resins, aromatic resins, C9 resins, pure monomer resins such as those having a-methylstyrene as the base, copolymer resins of the above-described monomers together and/or copolymer resins with phenol, styrenated terpene, terpene phenol resins, aromatic hydrocarbons, aromatic/aliphatic hydrocarbons, hydrogenated tackifiers, a-methylstyrene, and the like.

The quantity of the tackifier component in the adhesive is usually approximately 10 wt % to 45 wt %. The quantity of the tackifier component in the adhesive is more preferably approximately 20 wt % to 50 wt %, and even more preferably approximately 20 wt % to 40 wt %.

The adhesive used in the resin layer 13 may be an adhesive that includes both an adhesive component and a tackifier, or an adhesive that includes only the adhesive component or only the tackifier. For example, an adhesive composed only of a tackifier can be used.

In the mixture of the resin (resin material) and the adhesive, the resin (resin material) can be used as an adhesive component. In this case, the concentration of the adhesive in the resin layer 13 can be reduced by mixing in only the tackifier as the adhesive. It is thereby possible to suppress leaking of the adhesive into the electrolyte while preserving the adhesive function in the resin layer 13. Rosin or the like, for example, is preferred as such a tackifier.

A mixture is created by mixing the above-described resin (resin material) and adhesive, and the resin layer 13 of the positive electrode current collector 11 is configured from this mixture. Specifically, the resin layer 13 of the positive electrode current collector 11 is configured from a resin-adhesive mixture. As described above, the resin (resin material) and adhesive are preferably mixed so that the concentration of the adhesive in the resin layer 13 becomes low. The specific concentration of the adhesive included in the resin layer 13 is preferably more than 0 wt % and less than 3 wt % relative to the resin layer 13 (e.g., the entire resin layer 13), for example. Even more preferable is that the concentration be less than 1 wt %.

In order to achieve a balance between improving energy density and maintaining strength in the secondary cell, the thickness of the resin layer 13 is preferably 5 μm or more and 70 μm or less, and more preferably 10 μm or more and 50 μm or less. The resin layer 13 may be a resin film manufactured by any method of uniaxial stretching, biaxial stretching, non-stretching, and the like. Instead of a film shape, the resin layer 13 of the positive electrode current collector 11 may also have a fibrous shape, for example.

Furthermore, the melting point of the resin layer 13 is preferably 120° C. or more and 200° C. or less.

The positive electrode active material layers 12 are configured including a positive electrode active material that can occlude and discharge lithium ions. An oxide that contains lithium is a possible example of a positive electrode active material. Specifically, possible examples include LiCoO₂, LiFeO₂, LiMnO₂, LiMn₂O₄, and compounds in which some of the transition metals in these oxides are replaced with other metal elements.

Of these it is preferable that the positive electrode active material be one that can utilize 80% or more of the amount of lithium contained in the positive electrode in the cell reaction during normal use. It is thereby possible to increase the safety of the secondary cell in relation to overcharging and other accidents. Possible examples of such a positive electrode active material include compounds having a spinel structure such as LiMn₂O₄, compounds having an olivine structure expressed by LiₓMPO₄ (M being at least one element selected from Co, Ni, Mn, and Fe), and the like. Of these, a positive electrode active material containing Mn and/or Fe is preferable in terms of cost. Furthermore, it is preferable to use LiFePO₄ in terms of safety and charging voltage. LiFePO₄ is not susceptible to oxygen liberation due to temperature increase because all of the oxygen (O) is bonded with the phosphorus (P) by strong covalent bonds. Therefore, LiFePO₄ has excellent safety.

The thickness of the positive electrode active material layers 12 is preferably about 20 μm to 2 mm, and more preferably about 50 μm to 1 mm. Specifically, the thickness of the positive electrode active material layers 12 (the electrode thickness on one side) can be approximately 71 μm, for example. The amount of electrode coating on one side in this case can be 12 mg/cm², for example.

When the positive electrode active material layers 12 include at least a positive electrode active material, the configuration thereof is not particularly limited. For example, other than the positive electrode active material, the positive electrode active material layers 12 may include an electrical conductor, a thickener, a binder, and other materials.

The electrical conductor is not particularly limited as long as it is an electronically conductive material that does not adversely affect the cell performance of the positive electrodes 10. Possible examples include: carbon black, acetylene black, ketjen black, graphite (natural graphite, synthetic graphite), carbon fibers, and other carbon materials; electrically conductive metal oxides; and the like. Of these, carbon black and acetylene black are preferable as the electrical conductor in terms of their electronic conductivity and coatability.

Possible examples of the thickener include polyethylene glycols, celluloses, polyacrylamides, poly N-vinyl amides, poly N-vinyl pyrrolidones, and the like. Of these, polyethylene glycols, carboxymethyl celluloses (CMC) and other celluloses, and the like are preferable as the thickener, and CMC is particularly preferable.

The binder fulfills the role of binding active material particles and electrical conductor particles, and possible examples thereof include polyvinylidene fluoride (PVDF); polyvinyl pyridine; polytetrafluoroethylene and other fluoropolymers; polyethylene, polypropylene, and other polyolefin-based polymers; styrene butadiene rubber (SBR); and the like.

Possible examples of the solvent for dispersing the positive electrode active material, the electrical conductor, the binder, and the like include N-methyl-2-pyrrolidone, dimethyl formamide, dimethyl acetamide, methyl ethyl ketone, cyclohexanone, methyl acetate, methyl acrylate, diethyl triamine, N,N-dimethylaminopropylamine, ethylene oxide, tetrahydrofuran, and other organic solvents.

The positive electrodes 10 are formed, for example, by mixing the positive electrode active material, the electrical conductor, the thickener, and the binder, adding a suitable solvent to create a pasty positive electrode mixture, coating the surface of the positive electrode current collector 11 with the positive electrode mixture, drying the coating, and compressing the result to increase the electrode density if necessary.

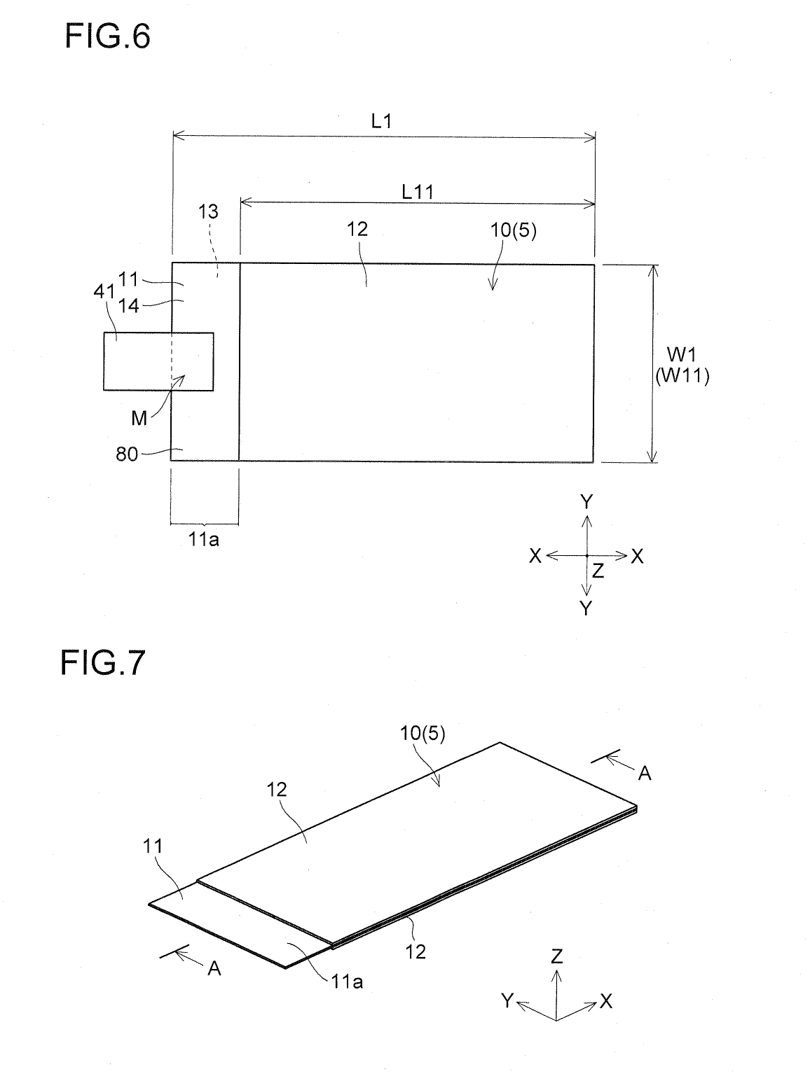

Each of the positive electrodes 10 described above, viewed in plan fashion, has a substantially rectangular shape as shown in FIG. 6. Specifically, in the first embodiment, the width W1 of the positive electrode 10 in the Y direction is approximately 140 mm, for example, and the length L1 in the X direction is approximately 295 mm, for example. The coated region (formed region) of the positive electrode active material layers 12 has a width W11 in the Y direction equal to the width W1 of the positive electrode 10 at approximately 140 mm, for example, and a length L11 in the X direction of approximately 280 mm, for example.

The positive electrode 10 has, at one end in the X direction, a current collector exposed part 11a where the positive electrode active material layers 12 are not formed and the surfaces (metal layers 14) of the positive electrode current collector 11 are exposed, as shown in FIGS. 5 through 7. A tab electrode 41 for outputting electric current to the exterior is electrically connected to the current collector exposed part 11a. The tab electrode 41 is formed into a shape approximately 30 mm in width and approximately 70 mm in length, for example. The thickness of the tab electrode 41 is approximately 100 μm, for example.

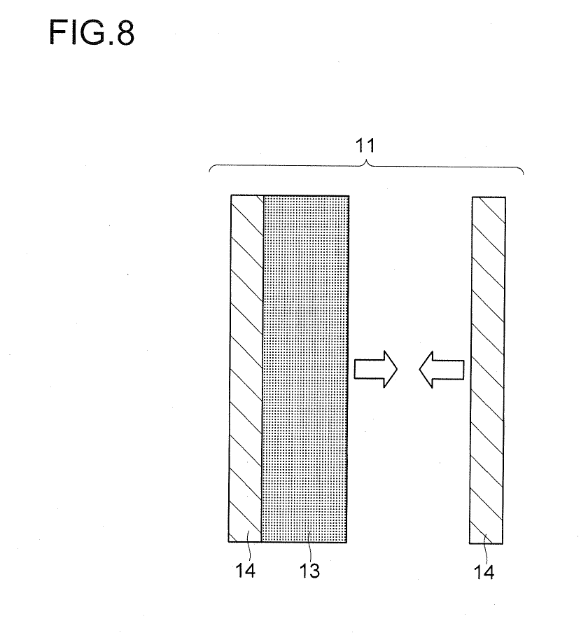

Here, the positive electrode current collector 11 is formed by using heat to melt the mixture of the resin (resin material) and adhesive, sandwiching the mixture in between two metal layers 14, and then drying the mixture (the resin layer 13), for example, as shown in FIG. 8. Therefore, there are no adhesive layers between the resin layer 13 and the metal layers 14.

The positive electrode current collector 11 can also be formed by a method other than those described above. For example, the positive electrode current collector 11 can also be formed by forming a sheet-shaped (film-shaped) resin layer 13 by forming the above-described mixture into a sheet shape (film shape) in advance, and sandwiching this sheet-shaped (film-shaped) resin layer 13 in between two metal layers 14. Regardless of the method used to form the positive electrode current collector 11, there are no adhesive layers between the resin layer 13 and the metal layers 14.

Because the resin layer 13 configured from the mixture of a resin (resin material) and adhesive has an adhesive function to a certain extent, the positive electrode current collector 11 having a multi-layered structure is formed by the adhesion of the resin layer 13 with the metal layers 14. As described above, the first embodiment has a configuration that omits adhesive layers containing a high concentration of an adhesive component (a tackifier component), due to the adhesive in the resin layer 13 being low in concentration.

Due to the positive electrode current collector 11 being configured in this manner, a lesser amount of the adhesive (the adhesive component) leaks into the electrolyte. There is thereby less peel-off and other problems in the metal layers 14 (the metal foil). There is concern over deterioration of the electrolyte and other problems when the adhesive (the adhesive component) leaks into the electrolyte. However, in the first embodiment, because leaking of the adhesive (the adhesive component) into the electrolyte has been prevented, deterioration of the electrolyte and other problems that are caused by the adhesive (the adhesive component) leaking into the electrolyte have been prevented.

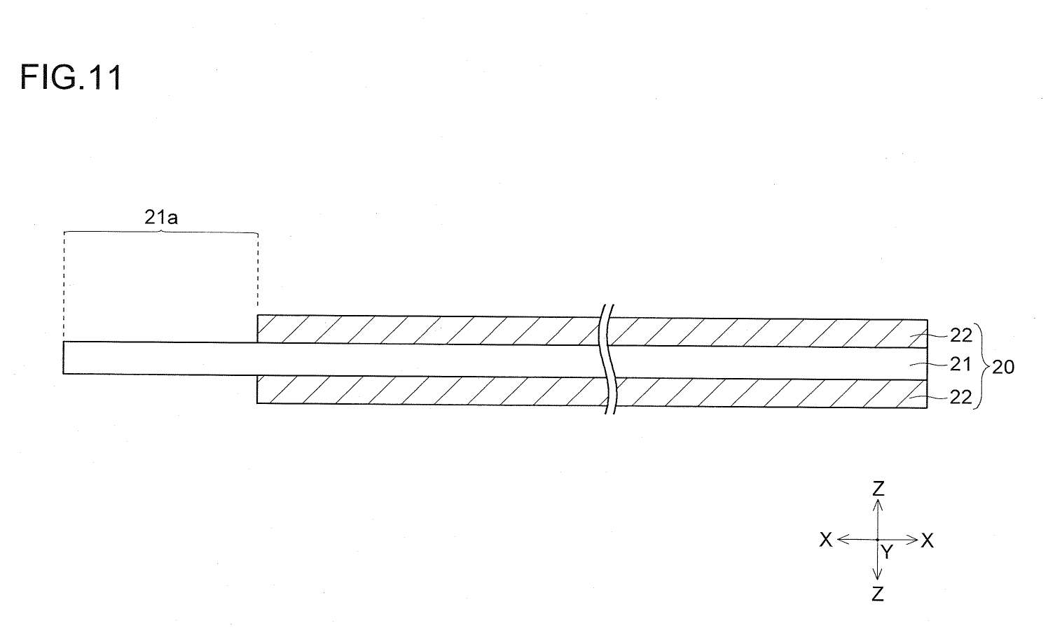

Each of the negative electrodes 20 constituting the electrode group 50 has a configuration in which negative electrode active material layers 22 are supported on both surfaces of a negative electrode current collector 21, as shown in FIG. 11. The negative electrode current collector 21 has the function of collecting current from the negative electrode active material layers 22.

In the first embodiment, the negative electrode current collector 21 has a configuration that does not include a resin layer, unlike the positive electrode current collector 11 (see FIG. 5). Specifically, in the first embodiment, only the positive electrode current collector 11 (see FIG. 5) is configured into a multi-layered structure that includes a resin layer.

Specifically, the negative electrode current collector 21 is configured from a metal foil of copper, nickel, stainless steel, iron, a nickel plating layer, or the like; or an alloy foil composed of an alloy of these metals, for example. A metal foil composed of copper or a copper alloy is preferable for the negative electrode current collector 21 since it tends not to alloy with lithium. The thickness of the negative electrode current collector 21 is approximately 1 μm to approximately 100 μm (e.g., approximately 12 μm), and is preferably 4 μm or more and 20 μm or less.

Instead of a foil, the negative electrode current collector 21 may be in the form of a film, a sheet, a netting, a punched or expanded article, a lath, a porous body, a foamed body, a fiber cluster, or other formation.

The negative electrode active material layers 22 are configured including a negative electrode active material that can that can occlude and discharge lithium ions. The negative electrode active material is composed of a material that includes lithium, or a material that can occlude and discharge lithium, for example.

To configure a high energy density cell, the electric potential for occluding/discharging lithium is preferably near the precipitation/dissolution electric potential of metallic lithium. A typical example is natural graphite or synthetic graphite in the form of particles (in the form of flakes, clumps, fibers, whiskers, balls, powdered particles, or the like).

The negative electrode active material may be synthetic graphite obtained by graphitization of mesocarbon microbeads, mesophase pitch powder, isotropic pitch powder, or the like. Graphite particles with amorphous carbon deposited on the surface can also be used. Furthermore a lithium transition metal oxide, a lithium transition metal nitride, a transition metal oxide, silicon oxide, and the like can also be used. When lithium titanate, typified by Li₄Ti₅O₁₂, for example, is used as the lithium transition metal oxide, there is less deterioration of the negative electrodes 20, and the life of the cell can therefore be prolonged.

The thickness of the negative electrode active material layers 22 is preferably about 20 μm to 2 mm, and more preferably about 40 μm to 1 mm. Specifically, the thickness of the negative electrode active material layers 22 (the electrode thickness on one side) can be approximately 45 μm, for example. The amount of electrode coating on one side in this case can be 6 mg/cm², for example.

The configuration of the negative electrode active material layers 22 is not particularly limited as long as it includes at least the negative electrode active material. For example, other than the negative electrode active material, the negative electrode active material layers 22 may include an electrical conductor, a thickener, a binder, and other materials. The same electrical conductor, thickener, binder, and other materials as for the positive electrode active material layers 12 (those capable of being used in the positive electrode active material layers 12) can be used.

The negative electrodes 20 described above are formed by mixing the negative electrode active material, the electrical conductor, the thickener, and the binder, adding a suitable solvent to create a pasty negative electrode mixture, coating the surface of the negative electrode current collector 21 with the negative electrode mixture, drying the coating, and compressing the result to increase the electrode density if necessary, for example.

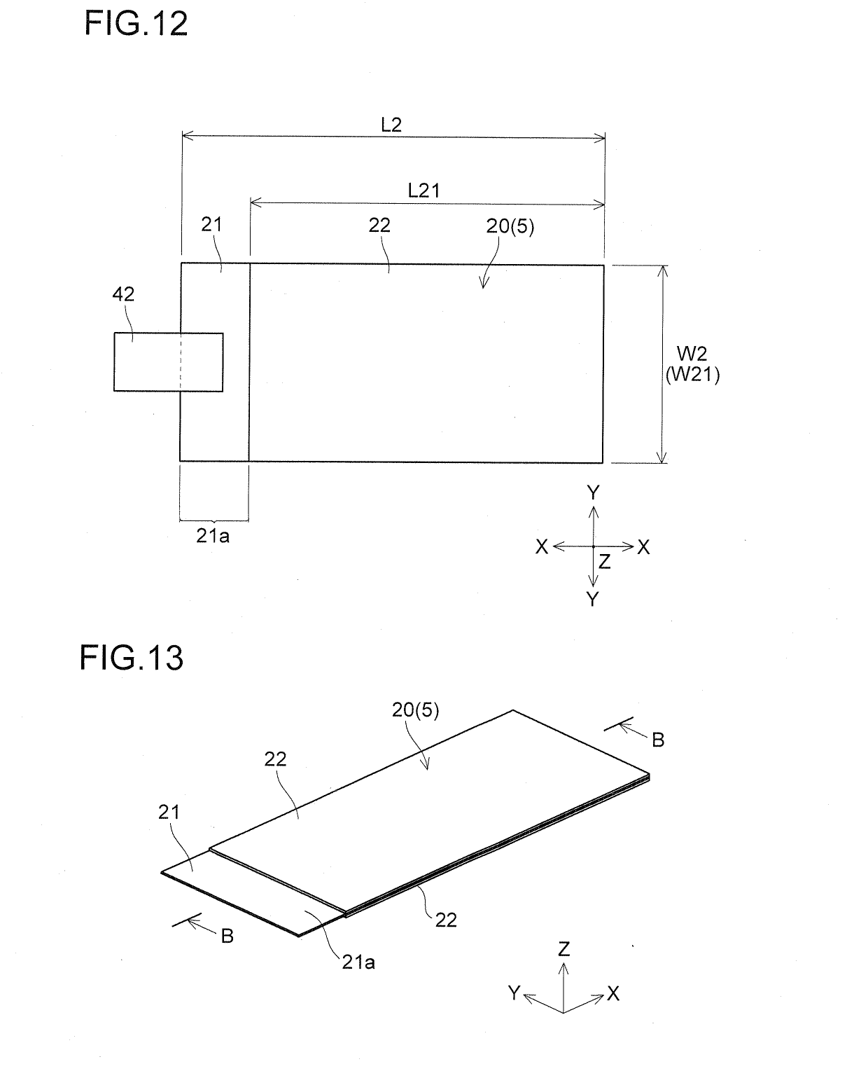

Each of the negative electrodes 20, shown in plan view, has a substantially rectangular shape as shown in FIG. 12, and is formed to be slightly larger than the positive electrodes 10 (see FIGS. 6 and 7). Specifically, in the first embodiment, each of the negative electrodes 20 has a width W2 in the Y direction of approximately 150 mm, for example, and a length L2 in the X direction of approximately 300 mm, for example. The coated region (formed region) of the negative electrode active material layer 22 has a width W21 in the Y direction equal to the width W2 of the negative electrode 20 at approximately 150 mm, for example, and a length L21 in the X direction of approximately 290 mm, for example.

Each of the negative electrodes 20, similar to the positive electrodes 10, has a current collector exposed part 21a at one end in the X direction, in which the negative electrode active material layer 22 is not formed and the surface of the negative electrode current collector 21 is exposed, as shown in FIGS. 11 through 13. A tab electrode 42 for drawing off electric current to the exterior is electrically connected to the current collector exposed part 21a. The tab electrode 42 is formed into a shape approximately 30 mm in width and approximately 70 mm in length, for example, similar to the tab electrode 41.

The separators 30 (see FIGS. 1 and 2) constituting the electrode group 50 can be appropriately selected from electrically insulating nonwoven fabrics and woven fabrics of synthetic resin fibers, glass fibers, natural fibers, or the like, as well as electrically insulating microporous films or the like. Of these, nonwoven fabrics and microporous films of polyethylene, polypropylene, polyester-based resins, aramid-based resins, cellulose-based resins, or the like are preferable in terms of their consistency of quality and other characteristics. Particularly preferable are nonwoven fabrics and microporous films composed of aramid-based resins, polyester-based resins, or cellulose-based resins.

The separators 30 preferably have a higher melting point than the resin layer 13 of the positive electrode current collector 11. For example, the separators 30 preferably have a thermal shrinkage rate of 1.0% or less at temperatures equal to or less than the melting point of the resin layer 13 of the positive electrode current collector 11. The thermal shrinkage rate may also be 1.0% or less at temperatures equal to or less than the heat distortion temperature of the resin layer 13 (heat distortion temperature<melting point).

The separators 30 are also preferably configured from a porous film including an aramid-based resin, a polyester-based resin, a cellulose-based resin, or the like, whose thermal shrinkage rate at 180° C. is 1.0% or less. The method for determining the thermal shrinkage rate of the separators 30 can be the same method as that for the resin layer 13 described above.

The thickness of the separators 30 is not particularly limited, but the thickness is preferably one at which the necessary amount of electrolyte can be retained, and is also preferably one at which short circuiting of the positive electrodes 10 and negative electrodes 20 can be prevented. Specifically, the separators 30 can have a thickness of 0.02 mm (20 μm) to 0.1 mm (100 μm), for example (more specifically, approximately 65 μm, for example).

The thickness of the separators 30 is preferably about 0.01 to 1 mm, and more preferably about 0.02 to 0.05 mm. The material constituting the separators 30 preferably has an air permeability per unit surface area (1 cm²) of about 0.1 sec/cm³ to 500 sec/cm³. A low cell internal resistance can thereby be maintained while ensuring a strength sufficient to prevent cell internal short circuiting.

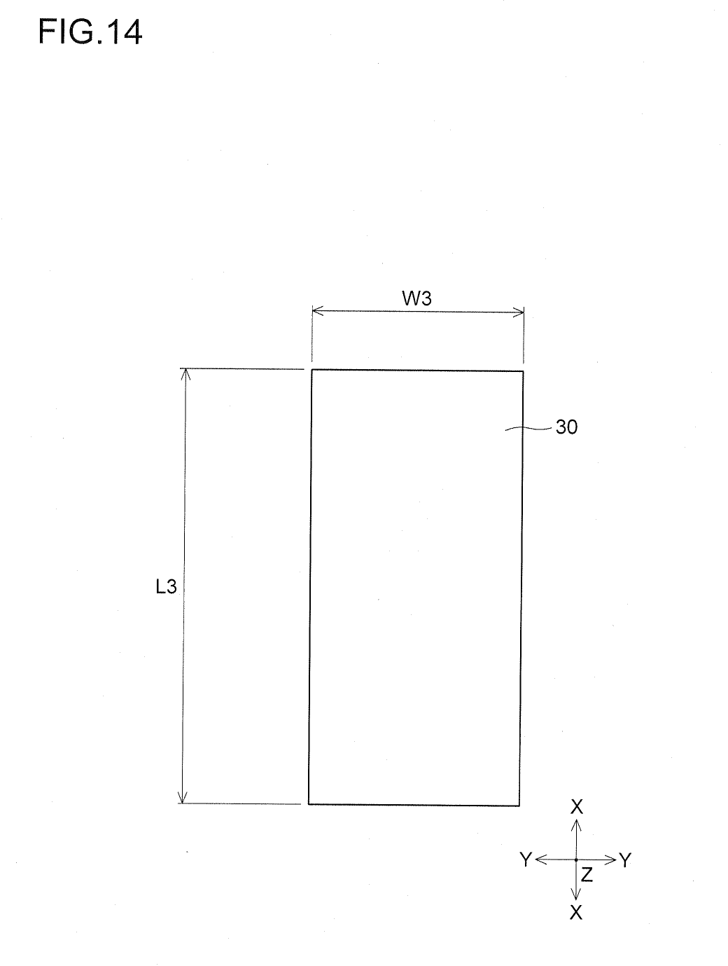

The separators 30 have a shape larger than the coated regions (the formed regions) of the positive electrode active material layers 12. Specifically, each of the separators 30 is formed into a rectangular shape, the width W3 in the Y direction being approximately 110 mm, for example, and the length L3 in the X direction being approximately 150 mm, for example, as shown in FIG. 14.

The positive electrodes 10 and the negative electrodes 20 described above are placed so that the current collector exposed parts 11a of the positive electrodes 10 and the current collector exposed parts 21a of the negative electrodes 20 are positioned on opposite sides from each other, and are stacked with the separators 30 interposed between the positive electrodes and negative electrodes, as shown in FIGS. 1 and 2.

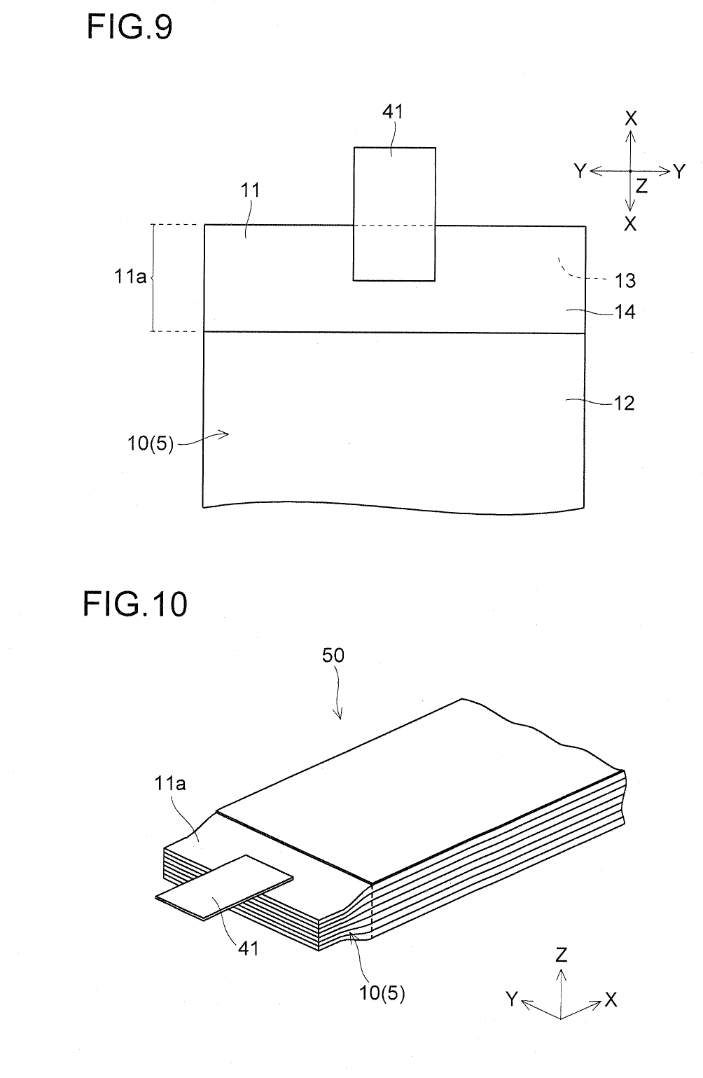

In the first embodiment, the plurality of positive electrodes 10 described above are stacked so that the current collector exposed parts 11a line up, as shown in FIGS. 9 and 10. The above-described tab electrode 41 is then fixed by welding to the outermost positive electrode 10 (the metal layer 14 of the positive electrode current collector 11). Instead of the outermost layer, the tab electrode 41 may also be fixed by welding to an intermediate-layer positive electrode 10. The tab electrode 41 is fixed by welding to the substantially central part in the width direction (Y direction) of the positive electrode current collector 11 (the positive electrode 10).

Because the positive electrode current collector 11 has a configuration in which the metal layers 14 are formed on both surfaces of the insulating resin layer 13, electrical conduction among the stacked positive electrodes 10 cannot be established. Therefore, the configuration preferably has metal foil (not shown) (the metal foil being sandwiched between positive electrodes 10) so that electrical conduction among the positive electrodes 10 (among the metal layers 14) can be established.

A plurality of negative electrodes 20 are stacked so that the current collector exposed parts 21a line up, similar to the positive electrodes 10, as shown in FIGS. 1 and 2. The above-described tab electrode 42 is then fixed by welding to the outermost negative electrode 20 (the negative electrode current collector 21). Similar to the case of the positive electrode, the tab electrode 42 may be fixed by welding to an intermediate-layer negative electrode 20 rather than the outermost layer. All of the stacked negative electrodes 20 are thereby in a state of being fixed by welding to the tab electrode 42 and electrically connected with the tab electrode 42. The tab electrode 42 is fixed by welding to the substantially central part in the width direction (Y direction) of the negative electrode current collector 21 (the negative electrode 20).

The welding of the tab electrodes 41 and 42 is preferably ultrasonic welding, but a technique other than ultrasonic welding, e.g., laser welding, resistance welding, spot welding, or the like, may be used. When the tab electrode 41 is welded to the positive electrode current collector 11 sandwiching the resin layer 13, however, laser welding, resistance welding, spot welding, and other means of bonding by adding heat have a risk of melting the resin layer 13. Therefore, ultrasonic welding which does not add heat is preferably used to weld the tab electrode 41.

The tab electrode 41 connected to the positive electrode 10 is preferably configured from aluminum, and the tab electrode 42 connected to the negative electrode 20 is preferably configured from copper. The tab electrode 41 and the tab electrode 42 preferably use the same material as the current collectors, but may use a different material. Furthermore, the tab electrode 41 connected to the positive electrode 10 and the tab electrode 42 connected to the negative electrode 20 may be either the same material or different materials. The tab electrode 41 and the tab electrode 42 are preferably welded to the substantially central parts in the width direction of the positive electrode current collector 11 and the negative electrode current collector 21 as described above, but may also be fixed by welding to regions other than the central parts.

The nonaqueous electrolyte enclosed along with the electrode group 50 in the external container 100 is not particularly limited. Esters, ethers, polar solvents, and the like, for example, can be used as the solvent of the nonaqueous electrolyte. Possible examples of the esters include ethylene carbonate (EC), propylene carbonate, butylene carbonate, diethyl carbonate (DEC), dimethyl carbonate, methylethyl carbonate, γ-butyrolactone, and the like. Possible examples of the ethers include tetrahydrofuran, 2-methyl tetrahydrofuran, dioxane, dioxolane, diethyl ether, dimethoxyethane, diethoxyethane, methoxyethoxyethane, and the like. Possible examples of the polar solvents include dimethyl sulfoxide, sulfolane, methyl sulfolane, acetonitrile, methyl formate, methyl acetate, and the like. These solvents may be used singly, or two or more solvents may be mixed and used as a mixed solvent.

The nonaqueous electrolyte may include an electrolyte supporting salt. Possible examples of the electrolyte supporting salt include LiClO₄, LiBF₄ (lithium borofluoride), LiPF₆ (lithium hexafluorophosphate), LiCF₃SO₃ (lithium trifluoromethanesulfonate), LiF (lithium fluoride), LiCl (lithium chloride), LiBr (lithium bromide), LiI (lithium iodide), LiAlCl₄ (lithium aluminate tetrachloride), and other lithium salts. These may be used singly, or mixtures of two or more may be used.

The concentration of the electrolyte supporting salt is not particularly limited, but is preferably 0.5 to 2.5 mol/L, and more preferably 1.0 to 2.2 mol/L. When the concentration of the electrolyte supporting salt is less than 0.5 mol/L, there is a risk that the concentration of the carrier that carries an electrical charge in the nonaqueous electrolyte will decrease and the resistance of the nonaqueous electrolyte will increase. When the concentration of the electrolyte supporting salt is higher than 2.5 mol/L, there is a risk that the degree of disassociation of the salt itself will decrease and the carrier concentration in the nonaqueous electrolyte will not increase.

The external container 100 enclosing the electrode group 50 is a large, flat, rectangular container, as shown in FIGS. 1 and 3. The external container 100 is configured including an external canister 60 for accommodating the electrode group 50 and the like, and a sealing plate 70 for sealing up the external canister 60. The sealing plate 70 is also attached, for example, by laser welding to the external canister 60 in which the electrode group 50 is accommodated.

The external canister 60 is formed by performing a deep drawing process or the like on a metal plate, for example, and is formed into substantially a box shape having a floor surface 61 and side walls 62. An opening 63 for inserting the electrode group 50 is also provided in one end of the external canister 60 (on the side opposite the floor surface 61), as shown in FIG. 1. The external canister 60 is formed into a size capable of accommodating the electrode group 50 so that the electrode surface of the electrode group 50 faces the floor surface 61.

In the external canister 60, an electrode terminal 64 (e.g., a positive electrode terminal) is formed in a side wall 62 on one side in the X direction (a short side), and an electrode terminal 64 (e.g., a negative electrode terminal) is formed in a side wall 62 on the other side in the X direction (a short side), as shown in FIGS. 1 and 3. A liquid inlet 65 for pouring in the nonaqueous electrolyte is formed in a side wall 62 of the external canister 60. This liquid inlet 65 is formed to a size of 2 mm in diameter, for example. In proximity to the liquid inlet 65, a safety valve 66 for releasing the cell internal pressure is formed.

Furthermore, a bent part 67 is provided around the circumferential edge of the opening 63 of the external canister 60, and the sealing plate 70 is fixed by welding to the bent part 67.

The external canister 60 and the sealing plate 70 can be formed using a metal plate of iron, stainless steel, aluminum, or the like; or a steel plate of nickel plated over iron, for example. Iron is an inexpensive material and is therefore preferable in terms of cost, but to ensure long-term reliability, it is more preferable to use a metal plate composed of stainless steel, aluminum, or the like; a steel plate of nickel plated over iron; or the like. The thickness of the metal plate can be approximately 0.4 to 1.2 mm, for example (approximately 1.0 mm, for example).

The electrode group 50 described above is accommodated in the external canister 60 so that the positive electrodes 10 and negative electrodes 20 face the floor surface 61 of the external canister 60. In the accommodated electrode group 50, the current collector exposed parts 11a of the positive electrodes 10 and the current collector exposed parts 21a of the negative electrodes 20 are electrically connected with the electrode terminal 64 of the external canister 60 via the tab electrodes 41 and 42.

The nonaqueous electrolyte is poured under reduced pressure, for example, through the liquid inlet 65 after the opening 63 of the external canister 60 has been sealed by the sealing plate 70. After a metal ball (not shown) of virtually the same diameter as the liquid inlet 65 or a metal plate (not shown) slightly larger than the liquid inlet 65 has been placed in the liquid inlet 65, the liquid inlet 65 is sealed by resistance welding, laser welding, or the like.

In the first embodiment, the resin layers 13 can be endowed with an adhesive function by forming the resin layers 13 of the positive electrode current collectors 11 from a mixture of a resin (resin material) and an adhesive as described above. Therefore, the resin layers 13 can be sandwiched by the metal layers 14 (the metal layers 14 can be adhered to the resin layer 13) without the use of interposed adhesive layers that include a high concentration of an adhesive (an adhesive component, a tackifier).

Leaking of the adhesive in the resin layers 13 into the electrolyte can be suppressed by using such a configuration. Specifically, electrolyte resistance can be improved. Peeling of the metal layers 14 from the resin layers 13 can thereby be suppressed. Consequently, by producing a lithium ion secondary cell using such current collectors (the positive electrode current collectors 11), the reliability of the cell can be improved.

In the first embodiment, the positive electrode current collectors 11 are formed into a multi-layered structure including the resin layers 13 as described above. Therefore, when abnormal overheating occurs in an overcharged state, a high-temperature state, or the like, for example, the resin layers 13 of the positive electrode current collectors 11 melt and the electrodes (the positive electrodes 10) are broken. The electric current can thereby be cut off. Consequently, temperature increases in the cell interior can be suppressed, and ignition and other abnormal states can therefore be prevented, for example.

In the first embodiment, the adhesive included in the resin layers 13 is more than 0 wt % and less than 3 wt % relative to the resin layers 13 (the entire resin layers 13). The adhesive in the resin layers 13 can thereby be effectively suppressed from leaking into the electrolyte. Specifically, by keeping the adhesive in the resin layers 13 at a low concentration, the amount of adhesive leaked into the electrolyte can easily be reduced while the adhesive function is preserved. Therefore, because peeling of the metal layers 14 in the positive electrode current collectors 11 and other problems can be effectively suppressed, the reliability of the cell can be effectively improved.

In the first embodiment, when the adhesive constituting the resin layers 13 is made from only a tackifier, the adhesive concentration in the resin layers 13 can be easily reduced. The adhesive in the resin layers 13 can thereby be more effectively suppressed from leaking into the electrolyte while the adhesive function is preserved.

When the melting point of the resin layers 13 is 120° C. or more and 200° C. or less, the resin layers 13 of the current collector can be made to melt readily when abnormal overheating occurs in an overcharged state, a high-temperature state, or the like, for example. Therefore, the electrodes (the positive electrodes 10) are broken readily, and safety can therefore be further improved.

In the first embodiment, the resin layers 13 of the positive electrode current collectors 11 may be formed from a thermoplastic resin, and the thermal shrinkage rate at 120° C. may be made 1.5% or more in any planar direction. Thereby, when abnormal overheating occurs in an overcharged state, a high-temperature state, or the like, for example, the electrodes can be made to be readily broken. Consequently, ignition and other abnormal states can be effectively prevented, and the safety of the lithium ion secondary cell can therefore be effectively improved.

In the first embodiment, the separators 30 may be formed to have a thermal shrinkage rate of 1.0% or less at temperatures equal to or less than the melting point or heat distortion temperature of the resin layers 13. The electrodes (the positive electrodes 10) can thereby easily be made to be readily broken when abnormal overheating occurs in an overcharged state, a high-temperature state, or the like. Specifically, due to the melting point (heat distortion temperature) of the separators 30 being higher than the melting point (heat distortion temperature) of the resin layers 13, the resin layers 13 constituting the positive electrode current collectors 11 can be melted before the shutdown function of the separators 30 activates. The electric current can thereby be cut off in two stages by the electric current cutoff effect of the resin layers 13 and the separators 30, and the safety of the lithium ion secondary cell can therefore be further improved.

When the thermal shrinkage rate of the separators 30 at 180° C. is 1.0% or less, the occurrence of internal short circuiting originating from thermal shrinkage of the separators 30 (internal short circuiting of the cell occurring at the ends of the electrodes) can be suppressed in the case that abnormal overheating occurs in an overcharged state or a high-temperature state. The occurrence of sudden temperature increases can therefore be suppressed, and the safety of the lithium ion secondary cell can be further improved.

Furthermore, with such a configuration, melting and fluidization of the separators 30 can be suppressed even at a temperature of 180° C. It is thereby possible to suppress the inconvenience of the holes of the separators 30 increasing in size because of melting and fluidization. Therefore, when the temperature of the cell interior reaches 180° C., it is possible to suppress the inconvenience of spreading areas of short circuiting in the positive electrodes and negative electrodes originating from the increase in size of the holes of the separators 30, even when no breakage has occurred in the electrodes (positive electrodes 10) for any reason.

### Second Embodiment

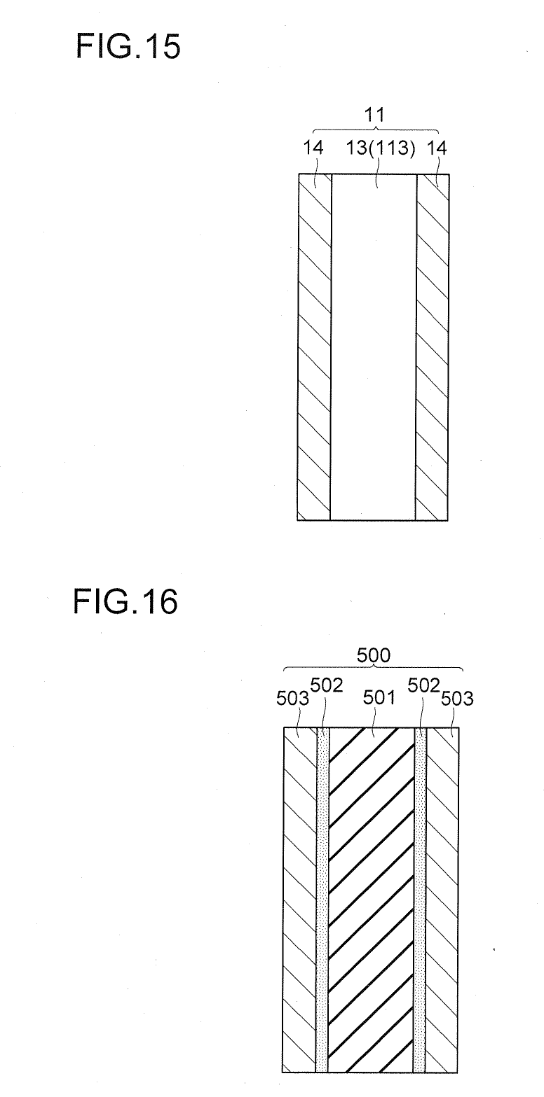

Next, FIG. 15 is a schematic cross-sectional view showing an enlargement of part of a positive electrode current collector of the lithium ion secondary cell according to the second embodiment of the present invention. In FIG. 15, configurational elements identical to those of the previously explained first embodiment are given the same symbols and redundant descriptions are appropriately omitted.

In the second embodiment, the resin layer 13 (113) of the positive electrode current collector 11 is formed from a resin (resin material) as shown in FIG. 15. Specifically, in the second embodiment, the resin layer 13 (113) is formed without an adhesive. In other words, this is the configuration of the first embodiment described above (the configuration of the positive electrode current collector), wherein the concentration of the adhesive included in the resin layer 13 is 0 wt %.

The resin (resin material) has an adhesive function to a certain extent, and the resin layer 13 (113) can therefore be endowed with an adhesive function even with such a configuration. The metal layers 14 (metal foil) are then adhered directly to the resin layer 13 (113) without the use of adhesive layers (not shown), whereby the positive electrode current collector 11 has a multi-layered structure that does not include an adhesive.

The positive electrode current collector 11 according to the second embodiment is formed by sandwiching the sheet-shaped (film-shaped) resin layer 13 (113) between two metal layers 14 (metal foil), and pressure-welding with a heat press or the like, for example.

The configuration of the second embodiment is otherwise identical to the first embodiment described above.

In the positive electrode current collector 11 according to the second embodiment, as described above, the resin layer 13 (113) does not have an adhesive that leaks into the electrolyte, due to being formed from a resin material. Therefore, peeling of the metal foil caused by the adhesive leaking into the electrolyte can be prevented.

The effects of the second embodiment are otherwise similar to the first embodiment described above.

Examples of the present invention are described hereinbelow. The present invention is not limited to the examples shown hereinbelow.

### Example 1

In Example 1, in the configuration of the first embodiment described above (the configuration of the positive electrode current collector), aluminum foil (thickness approximately 6.5 μm) was used for the metal layers, and a mixture of a resin and an adhesive ((resin: PE (polyethylene); tackifier: rosin (content<1 wt %)) was used for the resin layers. After the aluminum foils were attached with the mixture of the resin and adhesive, the result was dried, thereby producing a current collector having the following structure: aluminum foil layer/resin layer/aluminum foil layer. The thickness of the resin layer was 25 μm.

### Example 2

In Example 2, in the configuration of the second embodiment described above (the configuration of the positive electrode current collector), aluminum foil (thickness approximately 6.5 μm) was used for the metal layers, and a PE film (thickness approximately 30 μm, softening point 120° C.) was used for the resin layers. Thermal welding was then applied, thereby producing a current collector having the following structure: aluminum foil layer/resin film layer/aluminum foil layer.

### Comparative Example 1

In Comparative Example 1, aluminum foil (thickness approximately 6.5 μm) was used for the metal layers, a PE film (thickness approximately 30 μm, softening point 120° C.) was used for the resin layers, and an EVA-based adhesive material was used for the adhesive. A current collector was produced having the following structure: aluminum foil layer/adhesive layer/resin film layer/adhesive layer/aluminum foil layer. The thickness of the resin film layer was 35 μm.

### Comparative Example 2

In Comparative Example 2, aluminum foil (thickness approximately 6.5 μm) was used for the metal layers, and mixture of a resin and an adhesive (resin: PE; tackifier: rosin (content: 3 wt %)) was used for the resin layers. After the aluminum foil was attached with the resin adhesive, the result was dried, thereby producing a current collector having the following structure: aluminum foil layer/resin layer/aluminum foil layer. The thickness of the resin layer was 25 μm.

### Comparative Example 3

In Comparative Example 3, unlike Examples 1 and 2 and Comparative Examples 1 and 2 described above, the current collector did not have a multi-layered structure, but instead was a single metal layer. Specifically, aluminum foil (thickness approximately 20 μm) was the current collector in Comparative Example 3.

The current collectors in Examples 1 and 2 and Comparative Examples 1 through 3 described above were cut to dimensions of 5×5 cm. These were immersed for one week in an electrolyte (1M LiPF₆ 1% VC EC-DEC solution) in a 60° C. environment, whereby electrolyte resistance was evaluated. The results are shown in Table 1.

TABLE 1

| | | | Adhesive | | Adhesive | | |
|---|---|---|---|---|---|---|---|
| | Resin layer | | Adhesive | | concentration in | Electrolyte resistance | |
| | configuration | Resin | component | Tackifier | resin | Liquid coloration | Foil peel-off |
| Example 1 | resin adhesive | PE | — | rosin | <1 wt % | ∘ (no) | ∘ (no) |
| Example 2 | PE film | PE | — | — | — | ∘ (no) | ∘ (no) |
| Comp. Ex. 1 | adhesive/PE | PE | EVA | rosin | — | x (yes) | x (yes) |
| | film/adhesive | | | | | | |
| Comp. Ex. 2 | resin adhesive | PE | — | rosin | 3 wt % | x (yes) | x (yes) |
| Comp. Ex. 3 | none (Al foil only) | PE | — | — | — | ∘ (no) | — |

In Table 1, cases of successful visual confirmation of liquid coloration are indicated by “x (yes),” and cases of unsuccessful visual confirmation are indicated by “O (no).” To determine foil peel-off, the current collector was extracted from the electrolyte when the confirmation was to be made, and the current collector was washed with an EC-DEC solution and then dried. Visual confirmation of even some peel-off is indicated by “x (yes),” and no confirmation is indicated by “O (no).”

According to Table 1 above, in Comparative Example 1 in which adhesive layers were provided among the resin layers, the components included in the adhesive leached readily, and the foil peeled off. In Comparative Example 1, there was liquid coloration, from which it was confirmed that the components included in the adhesive had leaked into the electrolyte.

Foil peel-off was confirmed in Comparative Example 2 in which the adhesive concentration was 3% or more, even when the resin layers were a resin adhesive (a mixture of a resin and an adhesive). This is believed to be because there is marked leaking of the adhesive (the tackifier) into the electrolyte when rosin is used for the tackifier.

Such a phenomenon could not be confirmed when the concentration of the adhesive (tackifier) in the resin layers was low or when an adhesive was not included. Specifically, in Example 1, in which the resin layers included less than 1% of the adhesive (tackifier), it was confirmed from the lack of liquid coloration that leaking of the adhesive into the electrolyte was suppressed. There was also no confirmation of foil peel-off in Example 1. There was also no liquid coloration nor any confirmation of foil peel-off in Example 2 in which the resin layers did not include an adhesive.

As described above, the effect of impeding aluminum foil peel-off was confirmed with a current collector in which a mixture of a resin and an adhesive was used for the resin layers (Example 1). The effect of impeding aluminum foil peel-off was also confirmed with a current collector in which a resin material not including an adhesive was used for the resin layers (Example 2). From this it was clear that the current collectors of Example 1 and Example 2 had excellent electrolyte resistance.

However, when rosin is used as the tackifier and the concentration of rosin is high, the tackifier becomes prone to leakage into the electrolyte. Therefore, the concentration of the tackifier (rosin) is preferably made low in this case. Specifically, the concentration of the tackifier (rosin) is preferably made less than 3 wt %, and more preferably less than 1 wt %.

Example 1 and Example 2 both yielded the effect of excellent electrolyte resistance. However, since the resin layers include an adhesive in Example 1, mechanical strength (bonding strength and the like) is higher than in Example 2 in which the resin layers do not include an adhesive. Therefore, ease of handling and the like in the manufacturing process is improved. Consequently, Example 1 is superior when taking such matters into account.

In Example 1 and Comparative Example 2 described above, rosin was used as the tackifier, but foil peel-off can be suppressed even when a material other than rosin is used as the adhesive (adhesive component, tackifier), and also when the concentration of adhesive included in the resin layers is 3 wt % or more due to another adhesive and electrolyte combination or the like.

Next, lithium ion secondary cells were produced using the respective current collectors of Examples 1 and 2 and Comparative Examples 1 through 3 described above, and a nail penetration test was performed. Cells using the same positive electrode current collectors as Examples 1 and 2 and Comparative Examples 1 through 3 were designated respectively as Examples 3 and 4 and Comparative Examples 4 through 6. The method for producing the lithium ion secondary cells is shown hereinbelow.

### Examples 3 and 4, and Comparative Examples 4 through 6

Positive electrodes were produced using lithium iron phosphate for the active material, acetylene black (made by Denki Kagaku Kogyo Corporation: Denka Black) for the electrical conductor, and PVDF (made by Kureha Corporation) for the binder; an NMP solution containing a dispersion of the preceding in a weight ratio of 100:6:7 was used to coat the surfaces of the current collectors of Examples 1 and 2 and Comparative Examples 1 through 3, which were then dried. The amount of coating was 12 mg/cm², and the density was 1.9 g/cm³.

Negative electrodes were produced using natural graphite for the active material, synthetic graphite for the electrical conductor, SBR (made by Zeon Corporation: BM400B) for the binder, and CMC (made by Daicel Corporation: #2200) for the thickener; an aqueous dispersion of the preceding in a weight ratio of 88:10:1:1 was used to coat both surfaces of a copper foil (thickness approximately 10 μm), which was then dried. The amount of coating was 6 mg/cm², and the density was 1.5 g/cm³.

The positive electrodes were then processed into a size of 280 mm×140 mm, and the negative electrodes were processed into a size of 290 mm×150 mm. Next, using an aramid-based separator (melting point>200° C.), the positive electrodes and negative electrodes were stacked so as to be arranged as negative electrode 13 layers/positive electrode 12 layers in the sequence negative electrode/separator/positive electrode/, etc., and were then sealed with a laminate. An electrolyte (1M LiPF₆ 1% VC EC-DEC solution) was then poured in, resulting in a 15 Ah class cell. The cells using the respective positive electrode current collectors were designated as Examples 3 and 4 and Comparative Examples 4, 5, and 6.

The cells of Examples 3 and 4 and Comparative Examples 4 through 6 were given a full charge by CC/CV charging (1.5 A, cutoff voltage 3.6 V, cutoff current 0.15 A), after which a nail penetration test was performed. The nail penetration test was performed five times for each cell, and the tests were evaluated for three criteria: “smoke and ignition,” “smoke but no ignition,” and “no smoke and no ignition.” The results are shown in Table 2.

TABLE 2

| | | Nail penetration test | | |
|---|---|---|---|---|
| | | Smoke | Smoke but | No smoke, |
| | | and | no | no |
| | Current collector | ignition | ignition | ignition |
| Example 3 | same as Ex. 1 | 0 | 1 | 4 |
| Example 4 | same as Ex. 2 | 0 | 2 | 3 |
| Comp. Ex. 4 | same as Comp. Ex. 1 | 0 | 1 | 4 |
| Comp. Ex. 5 | same as Comp. Ex. 2 | 0 | 2 | 3 |
| Comp. Ex. 6 | same as Comp. Ex. 3 | 4 | 1 | 0 |

From Table 2 described above, Example 3 and Example 4 were confirmed to have the same cell safety as a conventional structure (Comparative Example 4). From these results, the current collector shown in the present example (embodiment) was confirmed to have yielded the same improvement in cell safety as the conventional structure.

In the first and second embodiments, an example was shown in which the present invention is applied to a lithium ion secondary cell which is one example of a nonaqueous secondary cell, but the present invention is not limited to this example; the present invention may also be applied to nonaqueous secondary cells other than a lithium ion secondary cell. The present invention can also be applied to nonaqueous secondary cells yet to be developed.

In the first and second embodiments, the resin layers (insulation layers) of the current collector may have any shape, such as a sheet (a film) or fibers. Possible examples of fibrous resin layers include layers composed of woven fabric, nonwoven fabric, or the like.

In the first and second embodiments, an example was shown in which metal foil was used for the metal layers of the positive electrode current collector, but the present invention is not limited to this example, and metal layers other than metal foil can be used as the metal layers of the positive electrode current collector. For example, the metal layers of the positive electrode current collector can be metal layers formed by vapor deposition, sputtering, electroplating, electroless plating, a combination of these methods, or the like.

In the structures of the first and second embodiments, leaking of the adhesive component into the electrolyte due to a concentration difference is suppressed because there is no location where a high concentration of the adhesive component is present, unlike a conventional structure. Furthermore, the adhesive component alone contributes to binding the insulation layers (resin layers) and current collector in a conventional structure, but in the structures of the embodiments, there is little decrease of binding strength due to leaching of the adhesive component because the adhesive component and the insulation layer component (the resin) both contribute. Consequently, there is less peeling of the current collector, and as a result, less leaching of the adhesive component from peeled surfaces.

In the first and second embodiments, an example was shown in which a flat rectangular container was used for the external container for accommodating the electrode group, but the present invention is not limited to this example; the shape of the external container need not be a flat rectangular shape. For example, the external container described above may be in the shape of a thin flat tube, a cylinder, a square tube, or the like. In the case of a large lithium ion secondary cell, the cell would preferably be thin and flat or rectangular because it would often be used as a battery pack. Furthermore, the external container described above may be an external container that uses a laminate sheet or the like, for example, instead of a metal canister.

Furthermore, in the first and second embodiments, an example was shown in which the present invention was applied to a stacked secondary cell, but the present invention is not limited to this example; the present invention may be applied to a wound cell, for example, instead of a stacked cell.

In the first and second embodiments, an example was shown in which the negative electrodes (the negative electrode active material layers) were formed to be larger than the positive electrodes (the positive electrode active material layers), but the negative electrodes (the negative electrode active material layers) and the positive electrodes (the positive electrode active material layers) may also be formed so as to be the same size. However, the negative electrodes (the negative electrode active material layers) are preferably formed so as to be larger than the positive electrodes (the positive electrode active material layers). With such a configuration, the formed regions of the positive electrode active material layers (the positive electrode active material regions) are covered by the formed regions of the negative electrode active material layers (the negative electrode active material regions) with larger surface area, whereby there can be a greater allowable range of stacking misalignment.

In the first and second embodiments, the external container can be varied in many ways not only in its shape, but also in its size, structure, and other characteristics. The shape of the electrodes (positive electrodes, negative electrodes), their dimensions, number used, and other characteristics can also be appropriately varied. Furthermore, the shape, dimensions, and other characteristics of the separators can also be appropriately varied. Various shapes can be used as the shape of the separators, e.g., a square, an oblong rectangle, a polygon, a circle, or the like.

In the first and second embodiments, an example was shown in which active material layers were formed on both sides of the current collectors, but the present invention is not limited to this example; an active material layer may be formed on only one side of each current collector. In an alternative configuration, a part of the electrode group includes electrodes (positive electrodes, negative electrodes) in which an active material layer is formed on only one side of each current collector.

In the first and second embodiments, an example was shown in which a nonaqueous electrolyte solution was used as the electrolyte of the lithium ion secondary cell, but the present invention is not limited to this example; instead of a nonaqueous electrolyte solution, a gel electrolyte, a polymer solid electrolyte, an inorganic solid electrolyte, a molten salt, or the like, for example, may be used as the electrolyte.

An example was shown in which the current collectors on the positive electrode side (the positive electrode current collectors) were formed in multi-layered structures including resin layers (insulation layers), but the present invention is not limited to this example; the current collectors on the negative electrode side may also be formed in multi-layered structures including resin layers and electrically conductive layers (metal layers). For example, both the positive electrodes and negative electrodes may be formed using current collectors having multi-layered structures, or either the positive electrodes or negative electrodes alone may be formed using current collectors having multi-layered structures. When either the positive electrodes or negative electrodes alone are formed using current collectors having multi-layered structures, those on the positive electrode side are preferably formed using current collectors having multi-layered structures.

In cases in which the current collectors on the negative electrode side are formed into multi-layered structures, the electrically conductive layers (the metal layers) are preferably formed from copper or a copper alloy. Specifically, for example, copper foil or a copper alloy foil having a thickness of approximately 6 to 15 μm can be used as the electrically conductive layers (the metal layers). The electrically conductive layers (the metal layers) of the negative electrode current collectors may be formed from a material other than copper or a copper alloy, e.g., nickel, stainless steel, iron, alloys thereof, or the like. The resin layers of the negative electrode current collectors can have the same configuration as the resin layers of the positive electrode current collectors, for example.

In the first embodiment, the adhesive included in the resin layers of the current collector is preferably low in concentration. For example, the concentration is preferably low enough not to require listing on the material safety data sheet (MSDS). The specific concentration of the adhesive in the resin layers is preferably less than 3 wt %, and more preferably less than 1 wt %, for example. With such a configuration, the resin layers can be endowed with an adhesive function, while leaking of the adhesive into the electrolyte can be effectively suppressed. In the examples described above, rosin (a tackifier) was used as an example of the adhesive, but leaking of the adhesive into the electrolyte can be suppressed even at an adhesive concentration of 3 wt % or more by using an adhesive (a tackifier, an adhesive component) other than rosin.

What is claimed is:

1. A current collector having a multi-layered structure comprising an insulation layer sandwiched by electrically conductive layers,
wherein the insulation layer is formed from a mixture of a resin material and an adhesive.

2. The current collector of claim 1, wherein
the adhesive included in the insulation layer is more than 0 wt % and less than 3 wt % relative to the insulation layer.

3. The current collector of claim 1, wherein
the adhesive included in the insulation layer has a tackifier, and
the tackifier includes rosin.

4. The current collector of claim 1, wherein
the adhesive is composed of only a tackifier.

5. The current collector of claim 1, wherein
the electrically conductive layers are in direct contact with the insulation layer.

6. The current collector of claim 1, wherein
the electrically conductive layers are composed of metal foil.

7. The current collector of claim 1, wherein
the melting point of the insulation layer is 120° C. or more and 200° C. or less.

8. A current collector having a multi-layered structure comprising an insulation layer sandwiched by metal foil, wherein
the insulation layer includes a resin material, and
the metal foil is in direct contact with the insulation layer.

9. The current collector of claim 8, wherein
melting point of the insulation layer is 120° C. or more and 200° C. or less.

10. A nonaqueous secondary cell comprising the current collector of claim 1, and an electrode including an active material layer formed on the current collector.

11. A nonaqueous secondary cell comprising the current collector of claim 8, and an electrode including an active material layer formed on the current collector.
